(19) United States
(12) Patent Application Publication
(10) Pub. No.: US 2026/0129344 A1
(43) Pub. Date: May 7, 2026

(54) EARPHONES

(71) Applicant: SHENZHEN SHOKZ CO., LTD., Shenzhen (CN)

(72) Inventors: Chunjian LIU, Shenzhen (CN); Junhao SUI, Shenzhen (CN); Guolin XIE, Shenzhen (CN)

(73) Assignee: SHENZHEN SHOKZ CO., LTD., Shenzhen (CN)

(21) Appl. No.: 19/435,616

(22) Filed: Dec. 29, 2025

Related U.S. Application Data
(63) Continuation of application No. PCT/CN2024/130590, filed on Nov. 7, 2024.

(51) Int. Cl. H04R 1/10; H04R 1/06; H04R 1/08

(52) U.S. Cl. CPC H04R 1/1066; H04R 1/06; H04R 1/086; H04R 1/1008; H04R 1/105; H04R 1/1075

(57) ABSTRACT

An earphone may include an ear hook and a sound producing assembly connected with the ear hook. The sound producing assembly includes a core housing, the ear hook includes an adapter housing and a hook portion, and the adapter housing has a mounting groove. The mounting groove has a first groove wall, a second groove wall opposite to the first groove wall, and a mounting opening located between the first groove wall and the second groove wall. The adapter housing is provided with a sound receiving hole. The earphone further includes a microphone and a support plate mounted between the first groove wall and the second groove wall through the mounting opening. The support plate is located between the microphone and the second groove wall to press the microphone against the first groove wall.

### CROSS-REFERENCE TO RELATED APPLICATIONS

This application is a continuation of an International Application No. PCT/CN2024/130590, filed on November 7, 2024, the contents of which are hereby incorporated by reference.

### TECHNICAL FIELD

The present disclosure generally relates to a field of electronic devices, and in particular to an earphone.

### BACKGROUND

With a continuous popularization of electronic devices, the electronic devices have become indispensable social and entertainment tools in people’s daily lives. People have increasingly higher requirements for the electronic devices. The electronic devices such as earphones and smart glasses have been widely used in people’s daily lives. These electronic devices may be used in conjunction with terminal devices such as mobile phones and computers to provide users with an auditory feast.

With the increasingly complex application scenarios of earphones, modern earphones are typically equipped with a microphone to collect user’s voice. However, it is difficult for the microphone to be fixedly assembled in an earphone housing. A sealing performance of the microphone is relatively poor, which also increases a difficulty of earphone manufacturing.

### SUMMARY

To solve the above technical problem, one technical solution adopted in the present disclosure is to provide an earphone including an ear hook and a sound producing assembly connected to the ear hook. In a wearing state, the ear hook is hooked between an auricle and a head of the user. The sound producing assembly is located on an anterior side of the auricle. The sound producing assembly includes a core housing. The ear hook includes an adapter housing and a hook portion. The adapter housing connects the core housing and the hook portion. The adapter housing has a mounting groove. The mounting groove has a first groove wall, a second groove wall opposite to the first groove wall, and a mounting opening located between the first groove wall and the second groove wall. The adapter housing is provided with a sound receiving hole. A sound outlet end of the sound receiving hole is located on the first groove wall. The earphone further includes a microphone and a support plate. The microphone and the support plate are mounted between the first groove wall and the second groove wall through the mounting opening. The support plate and the microphone are stacked, and the support plate is located between the microphone and the second groove wall, and presses the microphone against the first groove wall. The microphone is configured to collect sound external to the earphone through the sound receiving hole.

In some embodiments, the earphone includes a flexible circuit board and a main control circuit board. The main control circuit board is disposed in the core housing. The mounting opening faces the main control circuit board, a portion of the flexible circuit board extends into the mounting groove through the mounting opening and electrically connects the microphone and the main control circuit board.

In some embodiments, the support plate, the microphone, and a portion of the flexible circuit board achieve an interference fit with the mounting groove in a spacing direction between the first groove wall and the second groove wall.

In some embodiments, a dust-proof mesh assembly is disposed in the mounting groove. The dust-proof mesh assembly is located between the first groove wall and the microphone.

In some embodiments, a portion of the flexible circuit board is located between the microphone and the dust-proof mesh assembly. The sound outlet end of the sound receiving hole communicates with a sound collection area of the microphone, and the dust-proof mesh assembly, the portion of the flexible circuit board, and the microphone are pressed against the first groove wall by the support plate.

In some embodiments, the adapter housing includes a partition plate forming the mounting groove. The second groove wall is a surface of the partition plate facing the mounting groove, and the partition plate is provided with a recess.

In some embodiments, an opening of the recess faces a same direction as the mounting opening, and a length direction of the recess is arranged along a depth direction of the mounting groove.

In some embodiments, the support plate is made of metal or rigid plastic.

In some embodiments, the sound producing assembly has a connection end connecting the ear hook and a free end opposite to the connection end. The sound producing assembly has a thickness direction, a width direction, and a length direction that are mutually orthogonal, a depth direction of the mounting groove is arranged obliquely relative to the length direction. The length direction is a direction in which the connection end and the free end are spaced apart, and the thickness direction is a direction in which the sound producing assembly faces toward or away from the auricle in the wearing state.

In some embodiments, at least a portion of the sound receiving hole is arranged obliquely relative to a perpendicular direction of the first groove wall. In the wearing state, the adapter housing is adjacent to an upper ear root of the user. In the length direction, a sound inlet end of the sound receiving hole is closer to the free end than the sound outlet end of the sound receiving hole, and in the width direction, the sound inlet end of the sound receiving hole is farther from the upper ear root than the sound outlet end.

In some embodiments, an inclination angle of an extension direction of the at least a portion of the sound receiving hole relative to the perpendicular direction of the first groove wall is between 0° and 20°.

In some embodiments, the ear hook includes a soft covering layer. The soft covering layer covers the adapter housing. The sound receiving hole extends into and through the soft covering layer.

Beneficial effects of the present disclosure are as follows. Different from the prior art, the present disclosure provides the mounting groove on the adapter housing of the earphone. The sound receiving hole is provided in the second groove wall opposite to the first groove wall in the mounting groove. The earphone further includes the microphone and the support plate. The microphone and the support plate are installed between the first groove wall and the second groove wall of the mounting groove. The support plate presses the microphone against the second groove wall in the mounting groove. Thus, the microphone can be installed and fixed on the adapter housing. The microphone can also directly correspond to the sound receiving hole in the first groove wall. With such arrangement, the microphone can be pressed and fixed on the adapter housing only by using a simple structure and components. This can reduce an assembly difficulty of installing the microphone in the earphone, and reduce the assembly difficulty of the earphone. After the microphone is pressed against the first groove wall, a communication between the sound receiving hole and an internal space of the earphone can be avoided as much as possible. An air tightness between the microphone and the sound receiving hole can be improved. A sound collection effect of the microphone can be improved.

### BRIEF DESCRIPTION OF THE DRAWINGS

The present disclosure is further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating the anterior side profile of an ear of a user according to the present disclosure;

FIG. 2 is a schematic diagram illustrating a three-dimensional structure of one side of an earphone according to an embodiment of the present disclosure;

FIG. 3 is a schematic diagram of the earphone embodiment shown in FIG. 2 in a wearing state;

FIG. 4 is a schematic diagram illustrating a three-dimensional structure of one side of a sound producing assembly in the earphone in the embodiment shown in FIG. 2;

FIG. 5 is a schematic diagram illustrating a cross-sectional view of the sound producing assembly shown in FIG. 4 taken along section line A-A;

FIG. 6 is a schematic diagram illustrating a cross-sectional view of the sound producing assembly shown in FIG. 4 taken along section line B-B;

FIG. 7 is an enlarged schematic diagram illustrating a local area O of the sound producing assembly shown in FIG. 6;

FIG. 8 is a schematic diagram illustrating an exploded structure of the sound producing assembly shown in FIG. 4;

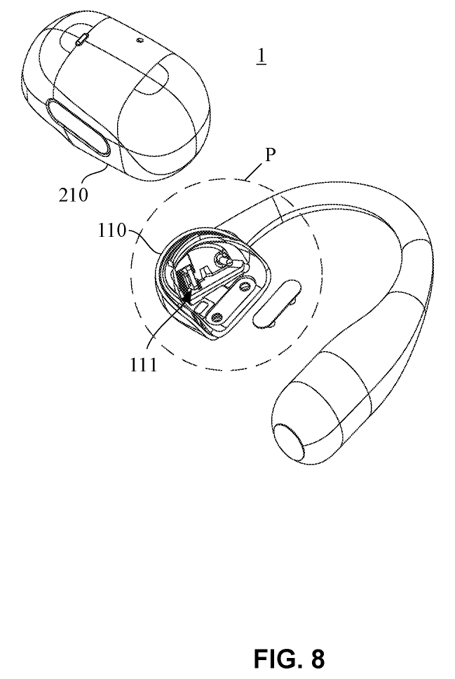

FIG. 9 is an enlarged schematic diagram illustrating a local area P of the sound producing assembly shown in FIG. 8;

FIG. 10 is a schematic diagram illustrating a structure of one side of an ear hook in the sound producing assembly shown in FIG. 4; and

FIG. 11 is a schematic diagram illustrating a structure of another side of the ear hook in the sound producing assembly shown in FIG. 4.

### DETAILED DESCRIPTION

The technical solutions in the embodiments of the present disclosure will be clearly and completely described below with reference to the accompanying drawings in the embodiments of the present disclosure. It is apparent that the described embodiments are only a part of the embodiments of the present disclosure, rather than all of the embodiments. All other embodiments obtained by those skilled in the art based on the embodiments of the present disclosure without creative efforts shall fall within the protection scope of the present disclosure.

The mention of “embodiment” in the present disclosure means that a specific feature, structure, or characteristic described in connection with the embodiment may be included in at least one embodiment of the present disclosure. Those skilled in the art explicitly and implicitly understands that the embodiments described in the present disclosure may be combined with other embodiments.

The following is an exemplary description of an earphone in an earphone embodiment.

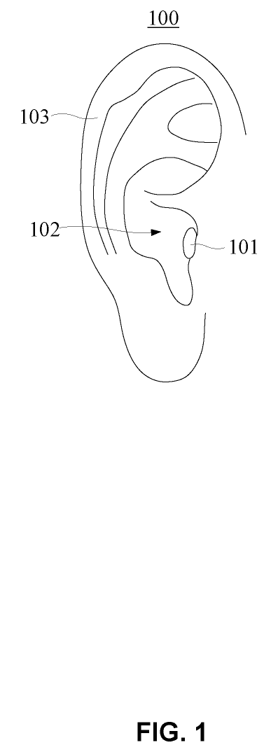

With reference to FIG. 1, an ear 100 of a user may include physiological parts such as an external ear canal 101, a concha cavity 102, an auricle 103, etc. Although the external ear canal 101 has a certain depth and extends to a tympanic membrane of the ear 100, for ease of description, the external ear canal 101 in the present disclosure refers to an entrance of the ear facing away from the tympanic membrane (i.e., an ear hole) unless otherwise specified. In addition, the concha cavity 102 has a certain volume and depth, and the concha cavity 102 is directly connected to the external ear canal 101, i.e., the aforementioned ear hole may be simply regarded as being located at a bottom of the concha cavity 102.

An earphone 1 is an audio converter capable of receiving an electrical signal from a media player or a receiver and converting the electrical signal into a sound wave that a user is able to hear. In some embodiments, the earphone 1 is an open earphone, e.g., an ear-hook earphone, a rear-hanging earphone, or an ear-clip earphone, etc.

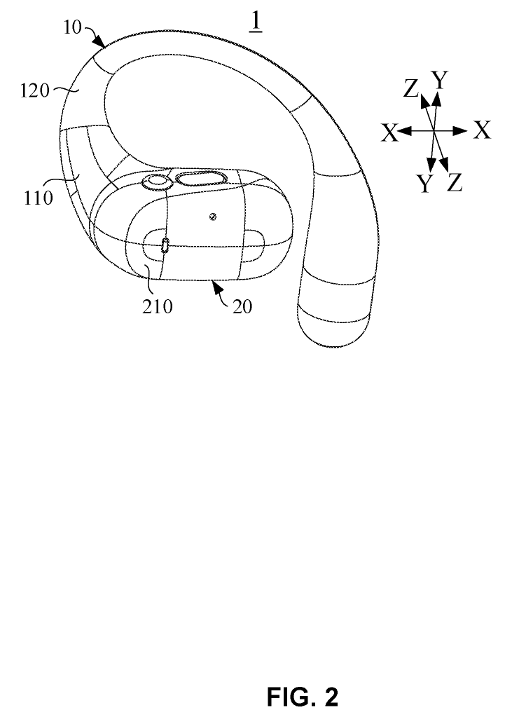

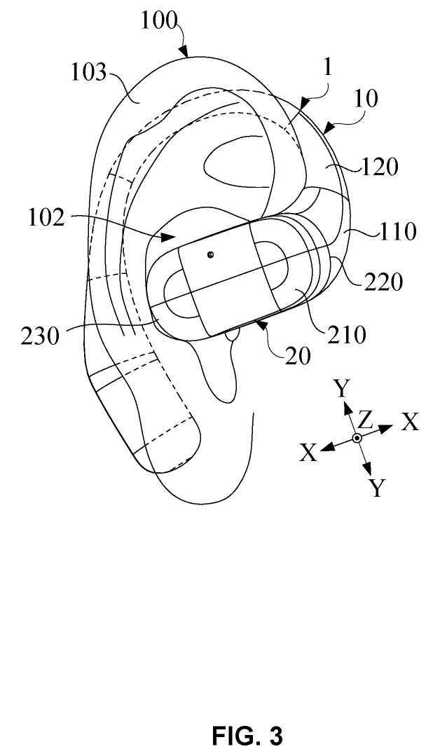

As shown in FIG. 2 or FIG. 3, the earphone 1 may be the ear-hook earphone. In some embodiments, in a wearing state, at least a portion of the earphone 1 may be inserted into the concha cavity 102 of the user to improve a wearing stability. In some embodiments, at least a portion of a sound producing assembly 20 of the earphone 1 covers at least a part of the auricle 103 of a user’s ear, e.g., such as an antihelix, a cymba conchae, or a triangular fossa (not shown in the figure), without obstructing the external ear canal 101 of the user’s ear or visually shielding the external ear canal 101 of the user’s ear. In some embodiments, the sound producing assembly 20 of the earphone 1 may conform against or abut a facial area in front of the user’s ear, and a side of the sound producing assembly 20 for producing sound faces the user’s ear or orients toward the external ear canal 101 of the user.

Furthermore, different users may have individual differences, resulting in dimensional differences such as different shapes and sizes of the ear 100. For ease of description and to reduce (or even eliminate) the individual differences of different users, a simulator including a head and ears 100 (left and right) thereof is manufactured based on ANSI: S3.36, S3.25 and IEC: 60318-7 standards, e.g., GRAS 45BC KEMAR, HEAD Acoustics, B&K 4128 series or B&K 5128 series, to present a scenario where most users wear the earphone 1. Taking GRAS KEMAR as an example, the simulator of the ear 100 may be any one of GRAS 45AC, GRAS 45BC, GRAS 45CC, or GRAS 43AG, etc. Taking HEAD Acoustics as an example, the simulator of the ear 100 may be any one of HMS II.3, HMS II.3 LN, or HMS II.3LN HEC, etc. Therefore, in the present disclosure, descriptions such as “a user wears the earphone 1,” “the earphone 1 is in a wearing state,” and “in a wearing state” may refer to the earphone 1 described in the present disclosure being worn on the ear 100 of the aforementioned simulator. Certainly, precisely because different users have individual differences, when the earphone 1 is worn by different users, there may be certain differences from the earphone 1 being worn on the ear 100 of the aforementioned simulator, but such differences should be tolerated.

It should be noted that in fields such as medicine and anatomy, three basic planes, namely a sagittal plane, a coronal plane, and a horizontal plane, and three basic axes, namely a sagittal axis, a coronal axis, and a vertical axis, may be defined for a human body or a human body simulator. The sagittal plane refers to a plane made along an anteroposterior direction of the body and perpendicular to the ground, which divides the human body or the human body simulator into left and right parts. The coronal plane refers to a plane made along a left-right direction of the body and perpendicular to the ground, which divides the human body or the human body simulator into front and rear parts. The horizontal plane refers to a plane made along a superior-inferior direction of the body and parallel to the ground, which divides the human body or the human body simulator into upper and lower parts. Correspondingly, the sagittal axis refers to an axis along the anteroposterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. Furthermore, the “front side of the ear” described in the present disclosure is a concept relative to the “rear side of the ear.” The “front side of the ear” refers to a side of the ear facing away from the head, and the “rear side of the ear” refers to a side of the ear facing toward the head. Both the “front side of the ear” and the “rear side of the ear” are directed to the ear 100 of the user or the simulator. When observing the ear 100 of the human body or the human body simulator along a direction of the coronal axis, it may be as shown in FIG. 1.

Merely by way of example, with reference to FIG. 2 and FIG. 3, the earphone 1 includes an ear hook 10 and a sound producing assembly 20 connected with the ear hook 10. In the wearing state, the ear hook 10 may be hooked between the auricle 103 and the head of a user, i.e., at least a portion of the ear hook 10 of the earphone 1 may be located at the rear side of the ear 100, so that the earphone 1 is hooked on the ear 100, and the sound producing assembly 20 may be located at the front side of the auricle 103. The sound producing assembly 20 may be a sound playback device. The sound producing assembly 20 may be configured to convert the electrical signal into a sound signal (which may also be referred to as the “sound wave” or the “audio signal”) and propagate the sound signal to the ear 100 of a wearer.

In some embodiments, a battery, or a circuit board, or other components is disposed in the ear hook 10, or both the battery and the circuit board are disposed in the ear hook 10. Certainly, the ear hook 10 may also not be provided with components such as the battery and the circuit board, and the components such as the battery and the circuit board may be installed in the sound producing assembly 20.

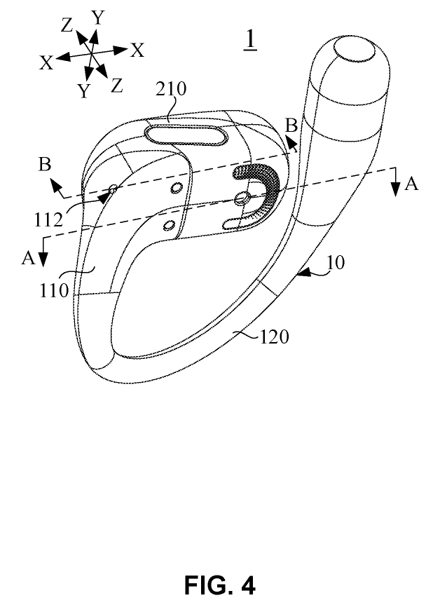

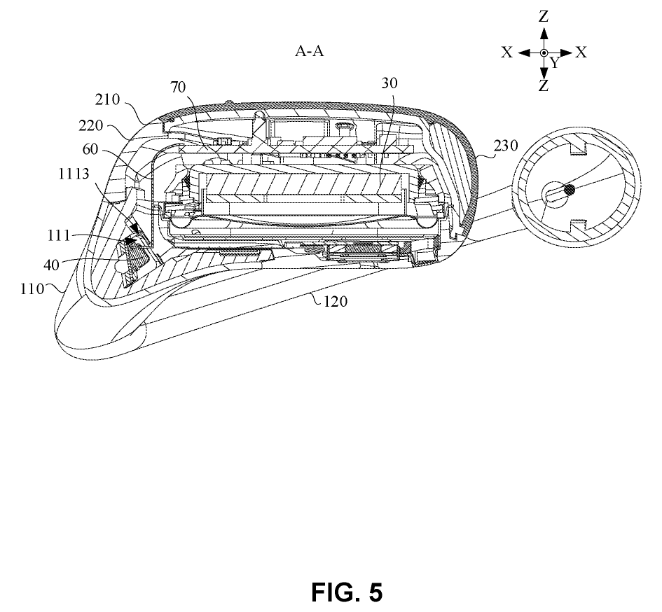

In some embodiments, as shown in FIGS. 1-5, the sound producing assembly 20 includes a core housing 210. In some embodiments, as shown in FIG. 5, the earphone 1 further includes a speaker assembly 30 disposed in the core housing 210. The speaker assembly 30 is a component capable of converting the electrical signal into the corresponding sound signal to realize a sound playback function of the sound producing assembly 20. Merely by way of example, the speaker assembly 30 may include a bone conduction speaker and an air conduction speaker. In other embodiments, the speaker assembly 30 may be one of the air conduction speaker and the bone conduction speaker.

In some embodiments, as shown in FIGS. 2-5, the ear hook 10 includes an adapter housing 110 and a hook portion 120. The adapter housing 110 may be configured to connect the core housing 210 and the hook portion 120. The hook portion 120 presents a hook shape for hooking on the ear 100 of the user when the user wears the earphone 1.

As shown in FIGS. 5-7, a mounting groove 111 may be disposed inside the adapter housing 110. The mounting groove 111 may have a first groove wall 1111 and a second groove wall 1112 disposed opposite to each other. The mounting groove 111 may also have a mounting opening 1113 located between the first groove wall 1111 and the second groove wall 1112. The adapter housing 110 may be provided with a sound receiving hole 112, and a sound outlet end 1121 of the sound receiving hole 112 is located in the first groove wall 1111.

The earphone 1 may further include a microphone 40 and a support plate 50. The microphone 40 and the support plate 50 are installed between the first groove wall 1111 and the second groove wall 1112 through the mounting opening 1113. The support plate 50 is disposed in a stacked configuration with the microphone 40 . The support plate 50 is located between the microphone 40 and the second groove wall 1112, and is configured to press the microphone 40 against the first groove wall 1111. The microphone 40 collects sound outside the earphone 1 through the sound receiving hole 112. The sound outside the earphone 1 may be, e.g., a user’s speech, a horn sound, a bicycle bell sound, surrounding human voices, a traffic command sound, etc.

Specifically, the support plate 50 and the microphone 40 are arranged in a stacked manner along an arrangement and spacing direction of the first groove wall 1111 and the second groove wall 1112. The support plate 50 may press the microphone 40 against the first groove wall 1111. The microphone 40 may be stabilized in the adapter housing 110 under a pressing action of the support plate 50 and a limiting action of the mounting groove 111. With such a configuration, the microphone 40 may be pressed and fixed on the adapter housing 110 by using only a simple structure and components, thereby reducing an assembly difficulty of installing the microphone 40 in the earphone 1 and also reducing an assembly difficulty of the earphone 1.

Moreover, the microphone 40 may directly correspond to the sound receiving hole 112 in the first groove wall 1111. After the microphone 40 is pressed against the first groove wall 1111, the sound receiving hole 112 may be prevented from communicating with an internal space of the earphone 1 as much as possible. In this way, the airtightness between the microphone 40 and the sound receiving hole 112 may be improved to improve a sound collection effect of the microphone 40.

In some embodiments, the support plate 50 is made of metal or rigid plastic. With such a configuration, the support plate 50 may have a certain anti-deformation capability, preventing the support plate 50 from deforming or being damaged during installation and when abutting against the microphone 40, thereby affecting the pressing effect on the microphone 40 and further affecting the airtightness of the earphone 1.

In some embodiments, as shown in FIG. 5, the earphone 1 includes a flexible circuit board 60 and a main control circuit board 70. The main control circuit board 70 may be disposed in the core housing 210. The mounting opening 1113 may face the main control circuit board 70. A portion of the flexible circuit board 60 may extend into the mounting groove 111 through the mounting opening 1113 and electrically connect the microphone 40 and the main control circuit board 70.

The main control circuit board 70 refers to a control core part inside the earphone 11. The main control circuit board 70 may be a printed circuit board (PCB), a flexible printed circuit board (FPC), or other circuit boards. The main control circuit board 70 may be electrically connected with the microphone 40 and the speaker assembly 30, respectively.

The flexible circuit board 60 (FPC) is a highly reliable and excellent flexible printed circuit board. The flexible circuit board 60 has characteristics of high wiring density, light weight, thin thickness, and good bendability. The flexible circuit board 60 is made of polyimide or polyester film as a base material. The flexible circuit board 60 is also referred to as a soft circuit board or a flex circuit board. Using the flexible circuit board 60 to connect the microphone 40 and the main control circuit board 70 may better adapt to a complex internal space of the earphone 1. The flexible circuit board 60 is less prone to damage compared to ordinary wires. Furthermore, the good bendability allows the flexible circuit board 60 to avoid other elements within the core housing 210 and the adapter housing 110.

Specifically, one end of the flexible circuit board 60 is connected with the main control circuit board 70 inside the core housing 210. The other end of the flexible circuit board 60 extends into the mounting groove 111 through the mounting opening 1113 and is connected with the microphone 40. By setting the mounting opening 1113 of the mounting groove 111 to face the main control circuit board 70, it is convenient for one end of the flexible circuit board 60 to connect with the main control circuit board 70 and for the other end of the flexible circuit board 60 to extend into the mounting groove 111. This arrangement reduces redundancy and folding of the flexible circuit board 60, and also reduces a likelihood of a short circuit occurring in the flexible circuit board 60.

In some embodiments, the support plate 50, the microphone 40, and a portion of the flexible circuit board 60 achieve an interference fit with the mounting groove 111 along a spacing direction between the first groove wall 1111 and the second groove wall 1112, so that the microphone 40 is tightly pressed against the first groove wall 1111. In other words, a distance between the first groove wall 1111 and the second groove wall 1112 is less than or equal to a sum of the thickness of the support plate 50, the thickness of the microphone 40, and the thickness of the portion of the flexible circuit board 60 extending into the mounting groove 111. It should be noted that the thickness mentioned here refers to a thickness of each component in a non-installed state.

With this arrangement, the components within the mounting groove 111 may be pressed together more tightly. The support plate 50, the microphone 40, and the portion of the flexible circuit board 60 may be more stably clamped between the first groove wall 1111 and the second groove wall 1112 to improves the overall airtightness of the earphone 1.

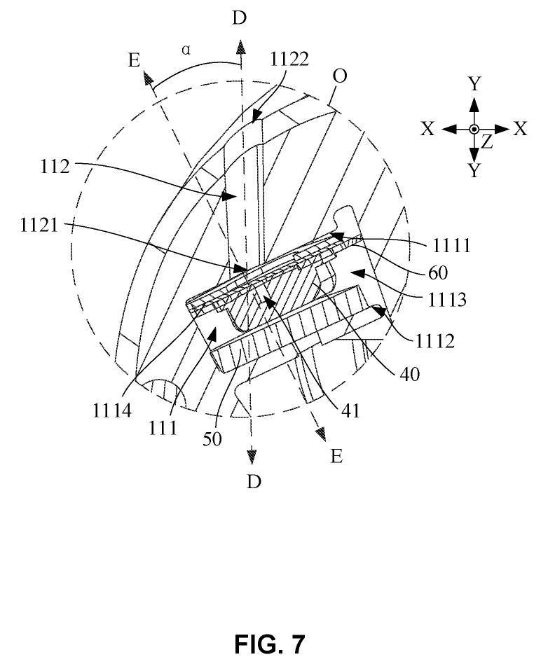

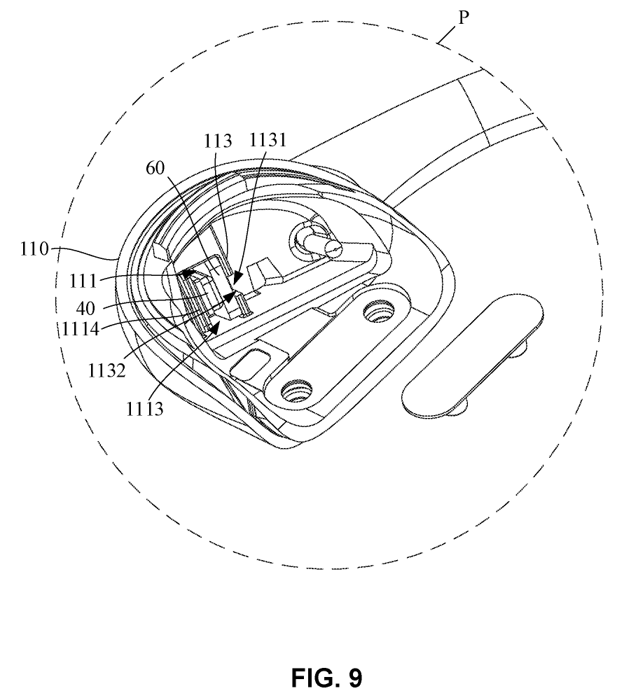

In some embodiments, as shown in FIG. 7 and FIG. 9, the mounting groove 111 is provided with a dust-proof mesh assembly 1114. The dust-proof mesh assembly 1114 may be located between the first groove wall 1111 and the microphone 40. The dust-proof mesh assembly 1114 may be used to isolate impurities such as dust, particles, water droplets in the air, etc., so that the impurities such as dust, particles , water droplets, etc., in the air are unlikely to enter the adapter housing 110 and the core housing 210, thereby reducing a risk of corrosion or damage to the internal components such as the speaker assembly 30, the main control circuit board 70, etc.

In some embodiments, the dust-proof mesh assembly 1114 includes components such as a steel mesh, a gauze mesh, an isolation cotton sheet, etc. (not shown). Alternatively, in other embodiments, the dust-proof mesh assembly 1114 includes components such as multiple layers of steel mesh or multiple layers of gauze mesh.

The dust-proof mesh assembly 1114 also achieves an interference fit with the mounting groove 111, the support plate 50, the microphone 40, and the portion of the flexible circuit board 60 along the spacing direction. In other words, the distance between the first groove wall 1111 and the second groove wall 1112 is less than or equal to a sum of the thickness of the dust-proof mesh assembly 1114, the thickness of the support plate 50, the thickness of the microphone 40, and the portion of the flexible circuit board 60 extending into the mounting groove 111. It should be noted that the thickness mentioned here refers to a thickness of each component in the non-installed state.

In some embodiments, a portion of the flexible circuit board 60 is located between the microphone 40 and the dust-proof mesh assembly 1114. The sound outlet end 1121 of the sound receiving hole 112 communicates with a sound collection area 41 of the microphone 40. The dust-proof mesh assembly 1114, the portion of the flexible circuit board 60, and the microphone 40 are all pressed against the first groove wall 1111 by the support plate 50. This makes it difficult for external sound and airflow to leak from a gap between the first groove wall 1111 and at least one of the dust-proof mesh assembly 1114, the portion of the flexible circuit board 60, and the microphone 40 when entering the sound collection area 41 of the microphone 40 through the sound receiving hole 112, and avoids the airflow from entering the adapter housing 110 and the core housing 210 as much as possible. As a result, the overall airtightness of the earphone 1 and the sound collection effect of the microphone 40 are improved.

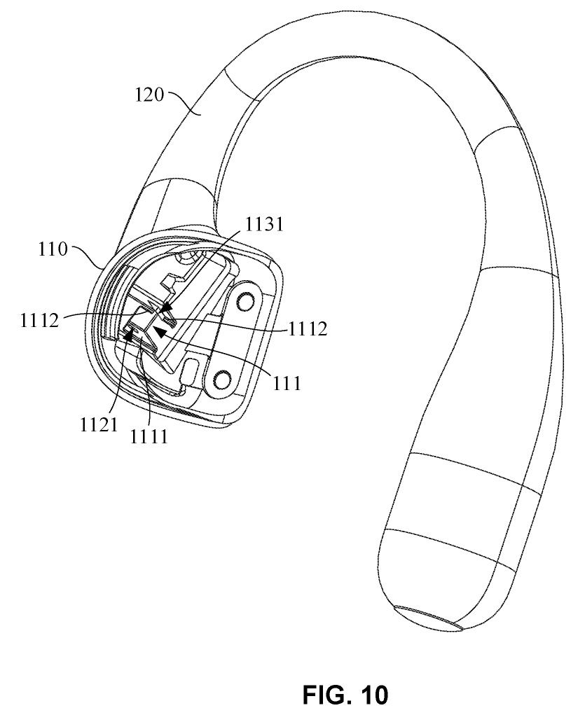

In some embodiments, as shown in FIGS. 9-11, the adapter housing 110 includes a partition plate 113 for forming the mounting groove 111. The second groove wall 1112 is a surface of the partition plate 113 facing the mounting groove 111. The partition plate 113 is provided with a recess 1131.

As the interference fit between the mounting groove 111 and the components such as the microphone 40 and the support plate 50 disposed in the mounting groove 111, both the first groove wall 1111 and the second groove wall 1112 undergo slight deformations. If a stiffness of the second groove wall 1112 is too high, an installation difficulty arises. If the stiffness of the second groove wall 1112 is too low, the deformation of the second groove wall 1112 may be relatively large when the components are installed, and the pressing effect of the support plate 50 on the components such as the microphone 40 becomes poor. Therefore, by providing the recess 1131 on the partition plate 113, the partition plate 113 where the second groove wall 1112 is located becomes more prone to undergo slight deformation, thereby allowing the components such as the microphone 40 and the support plate 50 to enter the mounting groove 111 more easily to reduce the installation difficulty of the microphone 40 and facilitate dimensional installation and debugging during the assembly process of the earphone 1, and reducing the assembly difficulty of the earphone 1. Simultaneously, this arrangement may also ensure that the partition plate 113 has a certain stiffness, and ensure the pressing effect of the support plate 50 on the components such as the microphone 40.

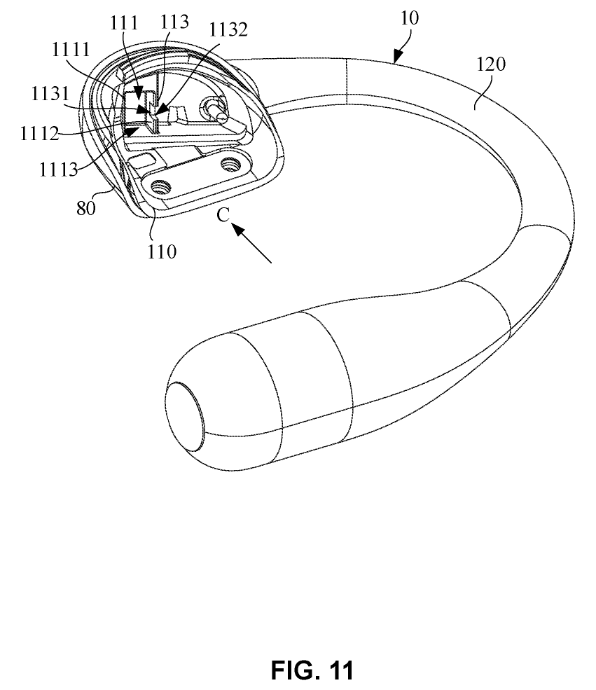

In some embodiments, as shown in FIG. 11, an opening 1132 of the recess 1131 and the mounting opening 1113 face a same direction. The length direction of the recess 1131 is set along the depth direction of the mounting groove 111. The depth direction of the mounting groove 111 is perpendicular to the spacing direction between the first groove wall 1111 and the second groove wall 1112. Merely by way of example, the depth direction of the mounting groove 111 is a direction indicated by arrow C in FIG. 11.

Specifically, the components such as the microphone 40 and the support plate 50 all enter the mounting groove 111 through the mounting opening 1113 and are further inserted into the mounting groove 111 along the depth direction of the mounting groove 111, to achieve the interference fit and installation with the mounting groove 111. If the opening 1132 of the recess 1131 faces the same direction as the mounting opening 1113, it indicates that the recess 1131 communicates with the mounting opening 1113. Setting the length direction of the recess 1131 to extend along the depth direction of the mounting groove 111 makes the partition plate 113 more prone to deform during the process of installing the microphone 40 and the support plate 50, and makes it easier for the microphone 40 and the support plate 50 to enter the mounting groove 111.

During the process of debugging and disassembling the microphone 40, the direction in which the microphone 40 and the support plate 50 are removed from the mounting groove 111 is a reverse direction of the depth direction of the mounting groove 111. Therefore, by setting the length direction of the recess 1131 along the depth direction of the mounting groove 111, the support plate 50 can be pushed out in the reverse direction of the depth direction of the mounting groove 111 by utilizing the recess 1131 during the debugging and disassembly process of the microphone 40. This facilitates the removal of the microphone 40 and other components from the mounting groove 111, thereby reducing the disassembly difficulty of the earphone 1.

In some embodiments, after the components such as the microphone 40 are assembled in the mounting groove 111, the mounting opening 1113 is subjected to a spot gluing or drip gluing treatment. The glue blocks the mounting opening 1113 to further fix the microphone 40 in the mounting groove 111. Furthermore, the glue may further cover a side of the partition plate 113 opposite to the support plate 50, so that the glue is not easy to fall off from the mounting opening 1113 after solidification.

In some embodiments, as shown in FIGS. 2-6, the sound producing assembly 20 has a connection end 220 connecting the ear hook 10 and a free end 230 opposite to the connection end 220. The sound producing assembly 20 has a length direction, a width direction, and a thickness direction that are mutually orthogonal. At least a portion of the free end 230 may extend into the concha cavity 102 or abut against the auricle 103 of the user.

The length direction may be a spacing direction between the connection end 220 and the free end 230. The spacing direction between the connection end 220 and the free end 230 refers to an extending direction of a line connecting the connection end 220 and the free end 230. In some embodiments, the connection end 220 and the free end 230 are irregular or regular arc shapes. The extending direction of the line connecting the connection end 220 and the free end 230 is defined as a direction of a straight line perpendicular to a parallel tangent plane of two reference points on the connection end 220 and the free end 230 that are farthest apart from each other. The length direction may also be defined as a direction in which the core housing 210 approaches or moves away from a back of the head in the wearing state, i.e., , a direction defined between a side surface of the sound producing assembly 20 close to the back of the head and a side surface of the sound producing assembly 20 away from the back of the head in the wearing state. Merely by way of example, the length direction is the direction indicated by arrow X in FIGS. 2-7. It should be noted that the length direction, the width direction, and the thickness direction of the sound producing assembly 20 defined using the wearing state in the present disclosure are all based on a coordinate system with the sound producing assembly 20 as the reference. The length direction, the width direction, and the thickness direction of the sound producing assembly 2are independent from the three basic axes of the human body and do not change due to slight differences when worn on different users’ ears.

The width direction may be defined as a direction in which the core housing 210 approaches or moves away from a top of the head in the wearing state, i.e.,+, a direction defined between the side surface of the sound producing assembly 20 close to the top of the head and the side surface of the sound producing assembly 20 away from the top of the head in the wearing state. Merely by way of example, the width direction is the direction indicated by arrow Y in FIGS. 3-7.

The thickness direction may be a direction in which the sound producing assembly 20 faces towards or away from the auricle 103 in the wearing state. Merely by way of example, the thickness direction is the direction indicated by arrow Z in FIGS. 2-7. The thickness direction Z may be substantially parallel to a vibration direction of the speaker assembly 30 in the sound producing assembly 20. The substantially parallel refers to that a spatial angle between the two directions is less than 5°.

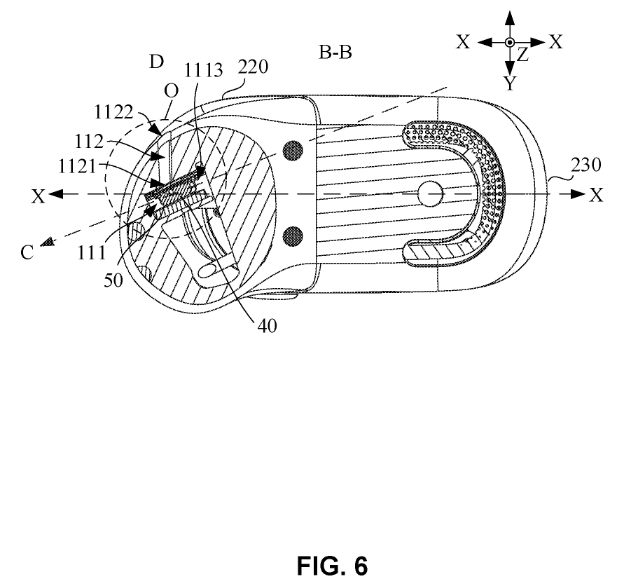

In some embodiments, as shown in FIG. 6, the depth direction of the mounting groove 111 is set obliquely relative to the length direction X. The depth direction of the mounting groove 111 may be the direction indicated by arrow C in FIG. 6. In other words, an angle between the depth direction C of the mounting groove 111 and the length direction X is not equal to 0°. Setting the depth direction C of the mounting groove 111 in this way makes a full use of an accommodation space of the adapter housing 110, improves a space utilization, and reduces a size occupied by the mounting groove 111 in the length direction X, thereby reducing the size of the earphone 1 in the length direction X and allowing the mounting opening 1113 to face the main control circuit board 70.

In some embodiments, at least a portion of the sound receiving hole 112 is arranged to be inclined relative to a vertical direction of the first groove wall 1111.

Merely by way of example, as shown in FIG. 7, the extending direction of at least a portion of the sound receiving hole 112 is shown as the direction of arrow D in FIG. 7, and the vertical direction of the first groove wall 1111 is shown as the direction of arrow E in FIG. 7.

Since the sound outlet end 1121 of the sound receiving hole 112 is located in the first groove wall 1111 and communicates with the sound collection area 41 of the microphone 40, and the sound outlet end 1121 of the sound receiving hole 112 penetrates through the housing where the first groove wall 1111 is located, arranging at least a portion of the sound receiving hole 112 to be inclined relative to a vertical direction E of the first groove wall 1111 causes an airflow to be blocked and weakened by the inclined hole wall of at least a portion of the sound receiving hole 112 after entering the sound inlet end 1122 of the sound receiving hole 112, thereby reducing a situation where the airflow directly impacts the microphone 40 after entering the sound inlet end 1122 of the sound receiving hole 112, so as to further reduce a wind noise and improve the sound collection effect of the microphone 40.

In some embodiments, an inclination angle of the extending direction of at least a portion of the sound receiving hole 112 relative to the vertical direction of the first groove wall 1111 is in a range of 0°-20°. Merely by way of example, the inclination angle of the extending direction of the at least a portion of the sound receiving hole 112 relative to the vertical direction of the first groove wall 1111 is 5°, 10°, 12°, 15°, or 18°, etc.

Merely by way of example, as shown in FIG. 7, the inclination angle of the extending direction D of at least a portion of the sound receiving hole 112 relative to the vertical direction E of the first groove wall 1111 is shown as angle α in FIG. 7, where 5° < angle α < 20°.

If the inclination angle of the extending direction D of the at least a portion of the sound receiving hole 112 relative to the vertical direction E of the first groove wall 1111 is equal to 0°, it indicates that the extending direction D of the sound receiving hole 112 is parallel to the vertical direction E of the first groove wall 1111, and when the airflow enters the sound inlet end 1122 of the sound receiving hole 112, it easily passes directly through the sound outlet end 1121 to impact the microphone 40, causing the microphone 40 to generate a significant wind noise. If the inclination angle of the extending direction D of the at least a portion of the sound receiving hole 112 relative to the vertical direction E of the first groove wall 1111 is greater than 20°, the sound receiving hole 112 occupies more space on the adapter housing 110, which increases the processing difficulty of the sound receiving hole 112, and also causes an excessive loss of effective sound information.

Therefore, setting the inclination angle of the extending direction D of the at least a portion of the sound receiving hole 112 relative to the vertical direction E of the first groove wall 1111 between 0° and 20° not only causes the airflow to be blocked and weakened by the inclined hole wall after entering the sound inlet end 1122 of the sound receiving hole 112, thereby reducing an impact force of the airflow on the microphone 40, improving the wind noise resistance of the earphone 1 and effectively enhancing a sound pickup effect of the microphone 40, but also reduces the space occupied by the sound receiving hole 112 in the adapter housing 110 and facilitates a processing and formation of the sound receiving hole 112 in the adapter housing 110.

In some embodiments, the extending direction of the entire sound receiving hole 112 is set to have the inclination angle between 0° and 20° relative to the vertical direction of the first groove wall 1111, which facilitates the formation of the sound receiving hole 112 in the adapter housing 110 and reduces the weakening of effective sound information by the sound receiving hole 112, thereby ensuring the sound collection effect and the wind noise resistance effect of the microphone 40.

Certainly, in other embodiments, a portion of the sound receiving hole 112 is inclined and another portion of the sound receiving hole 112 is curved, and the shapes of the portions in the sound receiving hole 112 are not listed one by one in this embodiment.

In some embodiments, the effective sound information refers to target information, e.g., call voice information or alert information, etc. In some embodiments, the effective sound information refers to target frequency band sound information, e.g., sound information in frequency bands of 500 Hz to 1 kHz, 1 kHz to 2 kHz, or 200 Hz to 2 kHz, etc.

In some embodiments, in the wearing state, the adapter housing 110 is arranged adjacent to an upper ear root of the user. In the length direction X, the sound inlet end 1122 of the sound receiving hole 112 may be closer to the free end 230 than the sound outlet end 1121 of the sound receiving hole 112.

Since, in a direction of the vertical axis of the human body (i.e., a relative direction from a head to feet of the human body), in the wearing state of the earphone 1, the free end 230 is closer to a mouth of the user than the connection end 220. Therefore, arranging the sound receiving hole 112 to be closer to the free end 230 than the sound outlet end 1121 in the length direction X allows the sound inlet end 1122 to be closer to the mouth of the user, thereby facilitating the microphone 40 to collect sound of the user through the sound receiving hole 112 to enhance the sound collection effect of the microphone 40.

In some embodiments, in the width direction Y, the sound inlet end 1122 of the sound receiving hole 112 is farther from the upper ear root than the sound outlet end 1121 of the sound receiving hole 112. Moreover, as the adapter housing 110 is arranged adjacent to the upper ear root of the user, arranging the sound receiving hole 112 such that the sound inlet end 1122 is farther from the upper ear root in the width direction Y than the sound outlet end 1121 allows the sound inlet end 1122 to be closer to the mouth of the user. This facilitates the microphone 40 to collect the sound of the user through the sound receiving hole 112, thereby enhancing the sound collection effect of the microphone 40.

In some embodiments, as shown in FIG. 11, the ear hook 10 includes a soft covering layer 80, the soft covering layer 80 envelops the adapter housing 110, and the sound receiving hole 112 extends into and through the soft covering layer 80.

Specifically, the mounting groove 111 is arranged on a side of the adapter housing 110 facing away from the soft covering layer 80. The sound inlet end 1122 of the sound receiving hole 112 may be located on a side of the soft covering layer 80 facing away from the adapter housing 110.

Providing the soft covering layer 80 to envelop the adapter housing 110 allows the adapter housing 110 to abut against the ear 100 of the user through the soft covering layer 80 in the wearing state of the earphone 1, thereby enabling the human body to contact a softer part, and improving user experience.

In some embodiments, the soft covering layer 80 is made of a flexible material such as silicone or thermoplastic elastomer (TPE).

In summary, the present disclosure provides the mounting groove 111 on the adapter housing 110 of the earphone 1, the sound receiving hole 112 is arranged in the second groove wall 1112 of the mounting groove 111 opposite to the first groove wall 1111. The earphone 1 is further provided with the microphone 40 and the support plate 50, the microphone 40 and the support plate 50 are installed between the first groove wall 1111 and the second groove wall 1112 of the mounting groove 111, and the support plate 50 presses the microphone 40 against the second groove wall 1112 within the mounting groove 111, thereby enabling the microphone 40 to be installed and fixed on the adapter housing 110 and enabling the microphone 40 to directly correspond to the sound receiving hole 112 in the first groove wall 1111. With such an arrangement, the microphone 40 may be pressed and fixed on the adapter housing 110 only by using a simple structure and components, which reduces the assembly difficulty of installing the microphone 40 in the earphone 1 and the assembly difficulty of the earphone 1, and after the microphone 40 is pressed against the first groove wall 1111, the sound receiving hole 112 may be prevented from communicating with the internal space of the earphone 1 as much as possible, and the airtightness between the microphone 40 and the sound receiving hole 112 may be improved to enhance the sound collection effect of the microphone 40.

The foregoing embodiments are merely illustrative and do not limit the patent scope of the present disclosure. Any equivalent structure or equivalent process transformation made based on the content of the present disclosure and the drawings, or direct or indirect application in other related technical fields, shall be similarly included within the patent protection scope of the present disclosure.

What is claimed is:

1. An earphone, comprising an ear hook and a sound producing assembly connected with the ear hook, wherein
in a wearing state, the ear hook is hooked between an auricle and a head of a user, the sound producing assembly is located on an anterior side of the auricle, the sound producing assembly comprises a core housing, the ear hook comprises an adapter housing and a hook portion, the adapter housing connects the core housing and the hook portion, and
the adapter housing has a mounting groove, the mounting groove having a first groove wall, a second groove wall opposite to the first groove wall, and a mounting opening located between the first groove wall and the second groove wall, the adapter housing is provided with a sound receiving hole, a sound outlet end of the sound receiving hole is located in the first groove wall,
the earphone further comprises a microphone and a support plate, the microphone and the support plate are mounted between the first groove wall and the second groove wall through the mounting opening, the support plate and the microphone are stacked, and the support plate is located between the microphone and the second groove wall, and presses the microphone against the first groove wall, the microphone is configured to collect sound external to the earphone through the sound receiving hole.

2. The earphone according to claim 1, wherein the earphone comprises a flexible circuit board and a main control circuit board, the main control circuit board is disposed in the core housing, the mounting opening faces the main control circuit board, a portion of the flexible circuit board extends into the mounting groove through the mounting opening and electrically connects the microphone and the main control circuit board.

3. The earphone according to claim 2, wherein the support plate, the microphone, and a portion of the flexible circuit board achieve an interference fit with the mounting groove in a spacing direction between the first groove wall and the second groove wall.

4. The earphone according to claim 3, wherein a dust-proof mesh assembly is disposed within the mounting groove, the dust-proof mesh assembly being located between the first groove wall and the microphone.

5. The earphone according to claim 4, wherein a portion of the flexible circuit board is located between the microphone and the dust-proof mesh assembly, the sound outlet end of the sound receiving hole communicates with a sound collection area of the microphone, and the dust-proof mesh assembly, the portion of the flexible circuit board, and the microphone are pressed against the first groove wall by the support plate.

6. The earphone according to claim 1, wherein the adapter housing comprises a partition plate forming the mounting groove, the second groove wall is a surface of the partition plate facing the mounting groove, and the partition plate is provided with a recess.

7. The earphone according to claim 6, wherein an opening of the recess faces a same direction as the mounting opening, and a length direction of the recess is arranged along a depth direction of the mounting groove.

8. The earphone according to claim 1, wherein the support plate is made of metal or rigid plastic.

9. The earphone according to claim 1, wherein the sound producing assembly has a connection end connecting the ear hook and a free end opposite to the connection end, the sound producing assembly has a thickness direction, a width direction, and a length direction that are mutually orthogonal, a depth direction of the mounting groove is arranged obliquely relative to the length direction, the length direction being a direction in which the connection end and the free end are spaced apart, and the thickness direction being a direction in which the sound producing assembly faces toward or away from the auricle in the wearing state.

10. The earphone according to claim 9, wherein at least a portion of the sound receiving hole is arranged obliquely relative to a perpendicular direction of the first groove wall, in the wearing state, the adapter housing is adjacent to an upper ear root of the user, in the length direction, a sound inlet end of the sound receiving hole is closer to the free end than the sound outlet end of the sound receiving hole, and in the width direction, the sound inlet end of the sound receiving hole is farther from the upper ear root than the sound outlet end.

11. The earphone according to claim 10, wherein an inclination angle of an extension direction of the at least a portion of the sound receiving hole relative to the perpendicular direction of the first groove wall is between 0° and 20°.

12. The earphone according to claim 1, wherein the ear hook comprises a soft covering layer, the soft covering layer envelops the adapter housing, and the sound receiving hole extends into and through the soft covering layer.

13. The earphone according to claim 1, wherein in the wearing state, at least a portion of the earphone is inserted into the concha cavity of the user.

14. The earphone according to claim 1, wherein at least a portion of the sound producing assembly covers at least a part of the auricle without obstructing an external ear canal of the user or visually shielding the external ear canal.

15. The earphone according to claim 1, wherein the microphone directly corresponds to the sound receiving hole in the first groove wall.

16. The earphone according to claim 4, wherein the dust-proof mesh assembly achieves an interference fit with the mounting groove, the support plate, the microphone, and the portion of the flexible circuit board along the spacing direction.

17. The earphone according to claim 10, wherein an inclination angle of an extension direction of the at least a portion of the sound receiving hole relative to the perpendicular direction of the first groove wall is between 5° and 20°.

18. The earphone according to claim 10, wherein in the wearing state, the adapter housing is arranged adjacent to an upper ear root of the user.

19. The earphone according to claim 12, wherein the mounting groove is arranged on a side of the adapter housing facing away from the soft covering layer.

20. The earphone according to claim 9, wehrein at least a portion of the free end extends into a concha cavity or abut against the auricle of the user.
